(19) United States
(12) Patent Application Publication
(10) Pub. No.: US 2024/0154119 A1
(43) Pub. Date: May 9, 2024

(54) NON-AQUEOUS ELECTROLYTE SECONDARY BATTERY

(71) Applicant: Panasonic Energy Co., Ltd., Moriguchi-shi, Osaka (JP)

(72) Inventors: Hideaki Fujiwake, Osaka (JP); Yuta Ichikawa, Osaka (JP); Takeshi Chiba, Osaka (JP)

(73) Assignee: Panasonic Energy Co., Ltd., Moriguchi-shi, Osaka (JP)

(21) Appl. No.: 18/281,671

(22) PCT Filed: Mar. 8, 2022
(86) PCT No.: PCT/JP2022/010026

§ 371 Date: Sep. 12, 2023

(30) Foreign Application Priority Data
Mar. 23, 2021 (JP) 2021-048932

(51) Int. Cl. H01M 4/583; H01M 4/02; H01M 4/36; H01M 4/38; H01M 10/052

(52) U.S. Cl. CPC H01M 4/583; H01M 4/364; H01M 4/366; H01M 4/382; H01M 10/052; H01M 2004/028

(57) ABSTRACT

A non-aqueous electrolyte secondary battery according to one embodiment of the present invention is provided with a positive electrode, a negative electrode, a non-aqueous electrolyte and a cladding. The cladding has a safety mechanism which operates when the internal pressure reaches a predetermined value. The positive electrode includes a positive electrode core and a positive electrode mixture layer formed on the positive electrode core. The positive electrode mixture layer includes a positive electrode active material, and 0.05-2 mass % of lithium carbonate relative to the mass of the positive electrode active material, and the lithium carbonate is present in a non-uniform concentration distribution in the thickness direction of the positive electrode mixture layer.

### TECHNICAL FIELD

The present disclosure relates to a non-aqueous electrolyte secondary battery, and in particular to a non-aqueous electrolyte secondary battery which has a safety mechanism which is actuated when an internal pressure reaches a predetermined value.

### BACKGROUND ART

In general, a non-aqueous electrolyte secondary battery such as a lithium ion battery includes a positive electrode, a negative electrode, a non-aqueous electrolyte, and an outer housing which houses these members. In the non-aqueous electrolyte secondary battery, when a battery voltage becomes too high upon occurrence of abnormality such as overcharging, gas is generated due to decomposition of the electrolyte or the like, resulting in possible increase of an internal pressure. Because of this, on the outer housing of the non-aqueous electrolyte secondary battery, a current shut-off mechanism which shuts off a charging current when the internal pressure has reached a predetermined value, or an explosion-proof mechanism which discharges the gas inside the battery is provided.

For example, Patent Literatures 1 and 2 disclose a non-aqueous electrolyte secondary battery in which lithium carbonate is added to the positive electrode. Patent Literatures 1 and 2 disclose that lithium carbonate is added, so as to realize an advantage that the current shut-off mechanism is reliably actuated at the time of overcharging, and the charging current is shut off.

Patent Literature 3 discloses a positive electrode for a lithium ion battery having a positive electrode mixture layer including a high-concentration region where a concentration of lithium carbonate is high, and a low-concentration region where the concentration of lithium carbonate is low. Patent Literature 3 discloses that lithium carbonate is produced by lithium in the positive electrode active material reacting with moisture in the atmosphere to produce lithium hydroxide, and the lithium hydroxide further reacting with carbon dioxide in the atmosphere to produce lithium carbonate, and that the concentration of lithium carbonate is higher at an upper layer side of the positive electrode mixture layer in comparison to a lower layer.

### CITATION LIST

### Patent Literature

PATENT LITERATURE 1: JP H04-328278 A
PATENT LITERATURE 2: JP 2001-307774 A
PATENT LITERATURE 3: WO 2011/121691

### SUMMARY

### Problem to be Solved

Although adding lithium carbonate to the positive electrode is effective in reliably actuating the safety mechanism such as the current shut-off mechanism, when an excessive amount of lithium carbonate is added to the positive electrode, an amount of active material is reduced, resulting in reduction of the capacity. In addition, the addition of lithium carbonate to the positive electrode may adversely affect battery characteristics under a high temperature environment. As such, the task here is to add a small amount of lithium carbonate so that the safety mechanism is quickly actuated.

An advantage of the present disclosure lies in provision of a no-aqueous electrolyte secondary battery in which, with an addition of a small amount of lithium carbonate, the safety mechanism can quickly be actuated upon occurrence of abnormality.

### Solution to Problem

According to one aspect of the present disclosure, there is provided a non-aqueous electrolyte secondary battery including: a positive electrode; a negative electrode; a non-aqueous electrolyte; and an outer housing, wherein the outer housing includes a safety mechanism which is actuated when an internal pressure reaches a predetermined value, the positive electrode includes a positive electrode core and a positive electrode mixture layer formed over the positive electrode core, the positive electrode mixture layer contains a positive electrode active material, and lithium carbonate in an amount of greater than or equal to 0.05 mass % and less than or equal to 2 mass % relative to a mass of the positive electrode active material, and the lithium carbonate is present in a non-uniform concentration distribution in a thickness direction of the positive electrode mixture layer.

### Advantageous Effects

According to a non-aqueous electrolyte secondary battery of an aspect of the present disclosure, the safety mechanism can be quickly actuated upon occurrence of abnormality, by the addition of a small amount of lithium carbonate.

### BRIEF DESCRIPTION OF DRAWINGS

FIG. 1 is a cross-sectional diagram of a non-aqueous electrolyte secondary battery according to an embodiment of the present disclosure.

FIG. 2 is a cross-sectional diagram of a positive electrode according to an embodiment of the present disclosure.

FIG. 3 is a diagram showing an increase curve of a battery voltage in an overcharge test.

### DESCRIPTION OF EMBODIMENTS

As described, when an excessive amount of lithium carbonate is added to the positive electrode, an amount of active material is reduced and capacity is reduced. On the other hand, when the amount of addition of lithium carbonate is too small, the actuation of the safety mechanism is slowed. Thus, it is necessary to efficiently cause a small amount of lithium carbonate to decompose upon occurrence of abnormality such as overcharging, so as to quickly actuate the safety mechanism.

The present inventors have eagerly studied for solving the above-described problem, and found that by adding lithium carbonate in an amount of greater than or equal to 0.05 mass % and less than or equal to 2 mass % to the positive electrode mixture layer, and causing lithium carbonate to be present in a non-uniform concentration distribution in a thickness direction of the mixture layer, it is possible to specifically suppress the voltage increase during overcharging. The suppression of the voltage increase during overcharging indicates that lithium carbonate is being efficiently decomposed. More specifically, when the voltage increase during overcharging is more gradual, the amount of generation of gas due to decomposition of lithium carbonate is higher, and the safety mechanism is actuated quicker. Therefore, by causing a predetermined amount of lithium carbonate to be present in the positive electrode mixture layer in the non-uniform concentration distribution in the thickness direction, it becomes possible to realize quick actuation of the safety mechanism while suppressing the adverse effect to the battery characteristic due to the addition of lithium carbonate.

In particular, when a configuration is employed in which a content of lithium carbonate in a second region positioned at a surface side of the positive electrode mixture layer is higher than that in a first region positioned on a positive-electrode-core side of the positive electrode mixture layer, the decomposition of lithium carbonate during overcharging is further promoted, resulting in a more significant improvement advantage of the actuation property of the safety mechanism. During overcharging, in the second region, polarization tends to become larger than the first region and a potential tends to become higher. Thus, it can be deduced that, with a larger content of lithium carbonate in the second region, the decomposition of lithium carbonate during overcharging progresses more efficiently.

A non-aqueous electrolyte secondary battery according to an embodiment of the present disclosure will now be described in detail with reference to the drawings. A selective combination of a plurality of embodiments and alternative configurations described below is included in the present disclosure.

In the following, a circular cylindrical battery will be exemplified in which an electrode assembly 14 of a wound type is housed in an outer housing can 16 of a circular cylindrical shape with a bottom, but the outer housing of the battery is not limited to the outer housing can of the circular cylindrical shape, and may alternatively be, for example, an outer housing can of a polygonal shape (polygonal battery), or an outer housing formed from laminated sheets including a metal layer and a resin layer (laminated battery). In addition, the electrode assembly may alternatively be an electrode assembly of a layered type, in which a plurality of positive electrodes and a plurality of negative electrodes are alternately layered with separators therebetween.

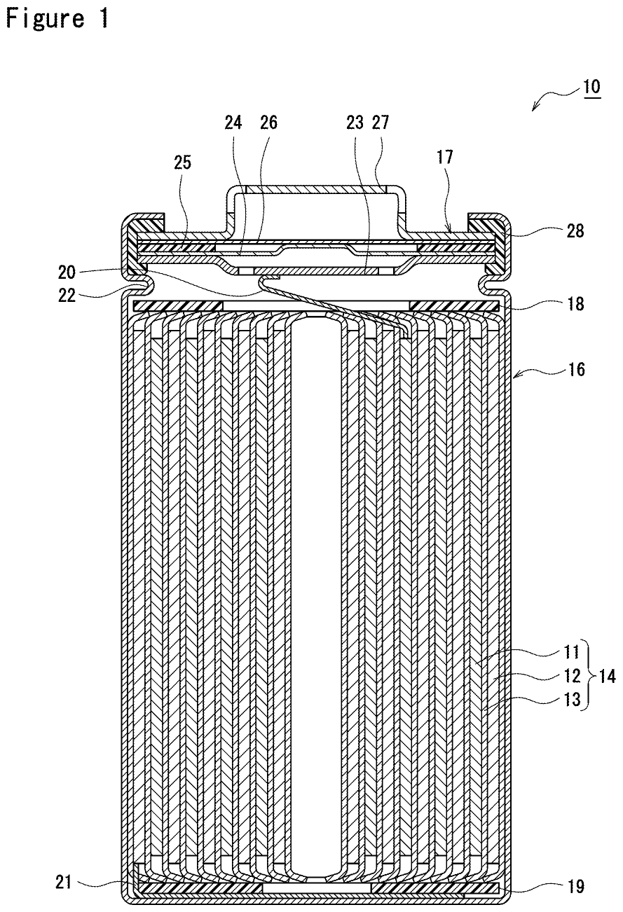

FIG. 1 is a diagram schematically showing a cross section of a non-aqueous electrolyte secondary battery 10 according to an embodiment of the present disclosure. As shown in FIG. 1, the non-aqueous electrolyte secondary battery 10 includes an electrode assembly 14 of a wound type, a non-aqueous electrolyte, and an outer housing can 16 which houses the electrode assembly 14 and the non-aqueous electrolyte. The electrode assembly 14 includes a positive electrode 11, a negative electrode 12, and a separator 13, and has a wound structure in which the positive electrode 11 and the negative electrode 12 are wound in a spiral shape with a separator 13 therebetween. The outer housing can 16 is a metal container having a circular cylindrical shape with a bottom, and opened on one side in an axial direction, and the opening of the outer housing can 16 is blocked by a sealing assembly 17. In the following, for convenience of description, a side of the sealing assembly 17 will be referred to as an “upper side”, and a side of a bottom of the outer housing can 16 will be referred to as a “lower side”.

The non-aqueous electrolyte includes a non-aqueous solvent and an electrolyte salt dissolved in the non-aqueous solvent. For the non-aqueous solvent, for example, esters, ethers, nitriles, amides, or a mixture solvent of two or more of these solvents may be employed. The non-aqueous solvent may include a halogen-substituted product in which at least a part of hydrogen atoms of the solvent described above is substituted with a halogen element such as fluorine. Examples of the non-aqueous solvent include ethylene carbonate (EC), ethylmethyl carbonate (EMC), dimethyl carbonate (DMC), and a mixture solvent of these solvents. For the electrolyte salt, for example, a lithium salt such as LiPF₆ is used. The non-aqueous electrolyte is not limited to a liquid electrolyte, and may alternatively be a solid electrolyte.

Each of the positive electrode 11, the negative electrode 12, and the separator 13 forming the electrode assembly 14 is an elongated member of a band shape, and these elements are alternately layered in a radial direction of the electrode assembly 14 by being wound in the spiral shape. The negative electrode 12 is formed in a slightly larger size than the positive electrode 11 in order to prevent precipitation of lithium. That is, the negative electrode 12 is formed longer in a longitudinal direction and a width direction (short-side direction) than the positive electrode 11. The separator 13 is formed in a slightly larger size at least than the positive electrode 11, and two separators 13 are placed sandwiching the positive electrode 11. The electrode assembly 14 has a positive electrode lead 20 connected to the positive electrode 11 through welding or the like, and a negative electrode lead 21 connected to the negative electrode 12 through welding or the like.

Insulating plates 18 and 19 are placed respectively above and below the electrode assembly 14. In the example configuration illustrated in FIG. 1, the positive electrode lead 20 extends through a through hole of the insulating plate 18 to the side of the sealing assembly 17, and the negative electrode lead 21 extends through an outer side of the insulating plate 19 to the side of the bottom of the outer housing can 16. The positive electrode lead 20 is connected to a lower surface of an internal terminal plate 23 of the sealing assembly 17 through welding or the like, and a cap 27 which is a top plate of the sealing assembly 17 electrically connected to the internal terminal plate 23 serves as a positive electrode terminal. The negative electrode lead 21 is connected to an inner surface of the bottom of the outer housing can 16 through welding or the like, and the outer housing can 16 serves as a negative electrode terminal.

As described above, the outer housing can 16 is a metal container having a circular cylindrical shape with a bottom, opened on one side in the axial direction. A gasket 28 is provided between the outer housing can 16 and the sealing assembly 17, so as to secure airtightness of the inside of the battery, and insulation between the outer housing can 16 and the sealing assembly 17. The outer housing can 16 has a grooved portion 22 in which a part of a side surface portion protrudes toward the inner side, and which supports the sealing assembly 17. The grooved portion 22 is desirably formed in an annular shape along a circumferential direction of the outer housing can 16, and supports the sealing assembly 17 with the upper surface thereof. The sealing assembly 17 is fixed at an upper part of the outer housing can 16 by the grooved portion 22 and an opening end of the outer housing can 16 crimped with respect to the sealing assembly 17.

The sealing assembly 17 has the internal terminal plate 23, a lower vent member 24, an insulating member 25, an upper vent member 26, and the cap 27, which are layered in this order from the side of the electrode assembly 14. The members of the sealing assembly 17 have, for example, a circular disk shape or a ring shape, and members other than the insulating member 25 are electrically connected to each other. The lower vent member 24 and the upper vent member 26 are connected to each other at respective center parts, and the insulating member 25 interposes between peripheral parts of the vent members. When abnormality occurs in the battery and an internal pressure of the battery increases, the lower vent member 24 deforms to push the upper vent member 26 toward the cap 27 and ruptures, and a current path between the lower vent member 24 and the upper vent member 26 is shut out. When the internal pressure further increases, the upper vent member 26 ruptures, and gas is discharged from an opening of the cap 27.

In the present embodiment, as described above, the outer housing of the battery is formed from the outer housing can 16 and the sealing assembly 17, and a safety mechanism which is actuated when the internal pressure of the outer housing becomes greater than or equal to a predetermined value is provided on the sealing assembly 17. One of the safety mechanism is a current shut-off mechanism formed by layering the lower vent member 24, the insulating member 25, and the upper vent member 26. Lithium carbonate added to the positive electrode 11 decomposes upon occurrence of abnormality such as overcharging, and causes the current shut-off mechanism to quickly be actuated at an appropriate timing. Further, the upper vent member 26 functions as an explosion-proof mechanism which ruptures during further increase of the internal pressure after actuation of the current shut-off mechanism and forms a discharge path of gas.

The positive electrode 11, the negative electrode 12, and the separator 13 forming the non-aqueous electrolyte secondary battery 10 will now be described in detail. In particular, the positive electrode 11 will be described in detail.

### [Positive Electrode]

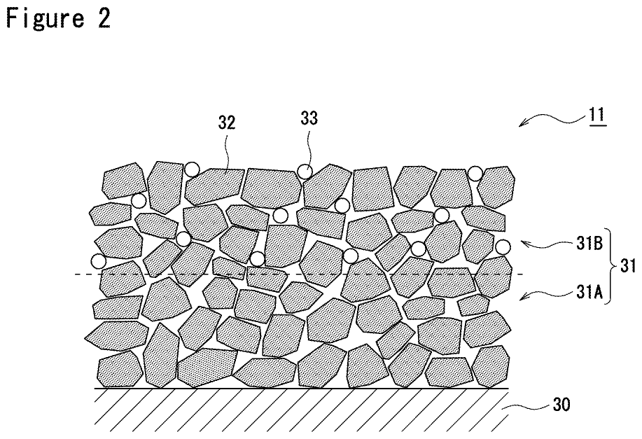

FIG. 2 is cross-sectional diagram showing a part of the positive electrode 11. As shown in FIG. 2, the positive electrode 11 includes a positive electrode core 30 and a positive electrode mixture layer 31 formed over the positive electrode core 30. For the positive electrode core 30, there may be employed a foil of a metal which is stable within a potential range of the positive electrode 11 such as aluminum and an aluminum alloy, a film on a surface layer of which the metal is placed, or the like. The positive electrode mixture layer 31 includes a positive electrode active material 32, a conductive agent, a binder, and lithium carbonate 33, and is desirably provided over both surfaces of the positive electrode core 30 other than a core exposed portion which is a portion to which the positive electrode lead is connected. A thickness of the positive electrode mixture layer 31 is, for example, greater than or equal to 50 μm and less than or equal to 150 μm on one side of the positive electrode core.

The positive electrode active material 32 is formed with a lithium-transition metal composite oxide as a primary component. As elements contained in the lithium-transition metal composite oxide other than Li, there may be exemplified Ni, Co, Mn, Al, B, Mg, Ti, V, Cr, Fe, Cu, Zn, Ga, Sr, Zr, Nb, In, Sn, Ta, W, Si, and P. A desirable example of the lithium-transition metal composite oxide is a composite oxide containing at least one of Ni, Co, and Mn. As a specific example, there may be exemplified a lithium-transition metal composite oxide containing Ni, Co, and Mn, and a lithium-transition metal composite oxide containing Ni, Co, and Al. A content of the positive electrode active material 32 is desirably greater than or equal to 90 mass % and less than or equal to 99 mass % relative to a mass of the positive electrode mixture layer, and is more desirably greater than or equal to 95 mass % and less than or equal to 98.5 mass %.

The positive electrode active material 32 is, for example, a secondary particle obtained by aggregation of a plurality of primary particles. An example of a volume-based median size (D50) of the positive electrode active material 32 is greater than or equal to 3 μm and less than or equal to 30 μm, and the volume-based median size (D50) is desirably greater than or equal to 5 μm and less than or equal to 20 μm. D50 is a particle size at which a volume accumulation value in the particularity distribution measured by laser diffractive scattering reaches 50%. An average value of the particle size (average particle size) of the positive electrode active material 32 measured though observation of a cross section of the positive electrode mixture layer 31 with a scanning electron microscope (SEM) is, for example, a value similar to D50. The particle size measured through the SEM observation is a diameter of a circumscribing circle of the particle, and the average particle size means an average value of particle sizes of 100 arbitrary particles (this is similarly applicable to lithium carbonate 33).

As the conductive agent included in the positive electrode mixture layer 31, there may be exemplified carbon materials such as carbon black, acetylene black, Ketjenblack, graphite, or the like. As the binder included in the positive electrode mixture layer 31, there may be exemplified a fluororesin such as polytetrafluoroethylene (PTFE), polyvinylidene fluoride (PVDF), or the like, polyacrylonitrile (PAN), polyimide, an acrylic resin, polyolefin, or the like. Alternatively, these materials may be used in combination with a cellulose derivative such as carboxymethyl cellulose (CMC) or a salt thereof, polyethylene oxide (PEO), or the like.

As described above, the positive electrode mixture layer 31 contains lithium carbonate 33. A content of lithium carbonate 33 is greater than or equal to 0.05 mass % and less than or equal to 2 mass % relative to the mass of the positive electrode active material 32. When the content of lithium carbonate 33 is lower than 0.05 mass %, the amount of generation of gas is small, and the improvement advantage of the actuation property of the safety mechanism cannot be obtained. On the other hand, when the content of lithium carbonate 33 exceeds 2 mass %, for example, the amount of the positive electrode active material 32 is reduced, resulting in a higher degree of capacity reduction, and also, possible reduction of high-temperature storage characteristic or the like. The content of lithium carbonate 33 is desirably greater than or equal to 0.05 mass % and less than or equal to 1 mass % relative to the mass of the positive electrode active material 32, and is more desirably greater than or equal to 0.1 mass % and less than or equal to 0.5 mass %.

Lithium carbonate 33 are particles having a smaller average particle size than the average particle size of the positive electrode active material 32, and are present in gaps between particles of the positive electrode active material 32. An example of the average particle size of lithium carbonate 33 is greater than or equal to 0.5 μm and less than or equal to 15 μm, and the average particle size is desirably greater than or equal to 1 μm and less than or equal to 10 μm. Lithium carbonate 33 may be fixed on a particle surface of the positive electrode active material 32. The D50 of lithium carbonate 33 is, for example, greater than or equal to 0.5 μm and less than or equal to 15 μm, and is desirably greater than or equal to 1 μm and less than or equal to 10 μm.

Lithium carbonate 33 is present in a non-uniform concentration distribution in the thickness direction of the positive electrode mixture layer 31. That is, in the thickness direction of the positive electrode mixture layer 31, there exist a region containing lithium carbonate 33 in a high concentration, and a region containing lithium carbonate 33 in a low concentration or containing no lithium carbonate 33 at all. As a result of the studies by the present inventors, it was found that, by locally adding a large amount of lithium carbonate 33, the decomposition reaction is promoted during the overcharging or the like. On the other hand, lithium carbonate 33 is present in a substantially uniform concentration distribution in a plane direction of the positive electrode mixture layer 31.

When the positive electrode mixture layer 31 is divided into two regions at a center in the thickness direction, a region positioned on the side of the positive electrode core 30 is defined as a first region 31A, and a region positioned on the side of the surface of the positive electrode mixture layer 31 is defined as a second region 31B, a content of lithium carbonate 33 may be larger in the first region 31A than in the second region 31B. Alternatively, lithium carbonate 33 may be contained substantially only in the first region 31A. That is, the positive electrode mixture layer 31 may have a two-layer structure including a lower layer on the side of the positive electrode core 30 and containing lithium carbonate 33, and an upper layer on the side of the surface and which does not contain lithium carbonate 33.

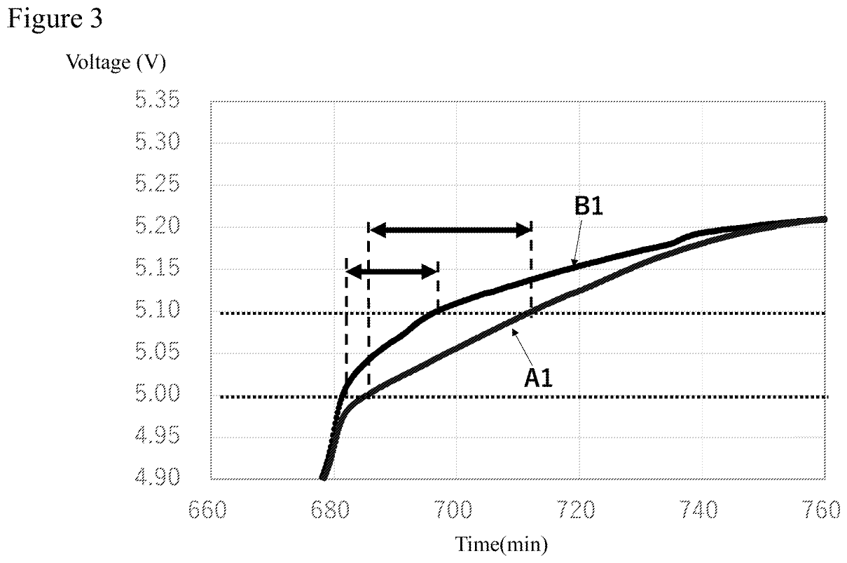

Alternatively, the positive electrode mixture layer 31 may have a three-layer structure, with only the intermediate layer containing lithium carbonate 33. In any of these configurations, the decomposition of lithium carbonate 33 during the overcharging or the like is promoted in comparison to a configuration in which lithium carbonate 33 is present in a uniform concentration distribution in the thickness direction of the positive electrode mixture layer 31. As shown in FIG. 3 to be described below, by having a local region of a large amount of lithium carbonate 33 in the thickness direction of the positive electrode mixture layer 31, it is possible to make the voltage increase during overcharging more gradual, resulting in improved safety of the battery.

It is sufficient that the content of lithium carbonate 33 is locally large in the thickness direction of the positive electrode mixture layer 31, but desirably, the content of lithium carbonate 33 is larger in the second region 31B than in the first region 31A. During the overcharging, a potential distribution exists in the thickness direction of the positive electrode mixture layer 31 and the potential tends to become high in the second region 31B. Thus, by having a larger amount of lithium carbonate 33 in the second region 31B, the promotion advantage of the decomposition of lithium carbonate 33 can be made more significant. Alternatively, lithium carbonate 33 may be contained substantially only in the second region 31B. In this case, the positive electrode mixture layer 31 has a two-layer structure including a lower layer which does not contain lithium carbonate 33, and an upper layer containing lithium carbonate 33.

The content of lithium carbonate 33 in the second region 31B is, for example, greater than or equal to 0.05 mass % and less than or equal to 2 mass % relative to the mass of the positive electrode active material 32 contained in the second region 31B, is desirably greater than or equal to 0.1 mass % and less than or equal to 1.5 mass %, and is more desirably greater than or equal to 0.2 mass % and less than or equal to 1 mass %. The content of lithium carbonate 33 in the first region 31A is desirably lower than or equal to 1 mass % relative to the mass of the positive electrode active material 32 contained in the first region 31A, and may be substantially 0 mass %. The content of lithium carbonate 33 can be adjusted, for example, by changing contained ratios of positive electrode active material 32 and lithium carbonate 33 while setting the contents of the conductive agent and the binder to be constant over all regions of the positive electrode mixture layer 31. Examples of the contents of the conductive agent and the binder are respectively greater than or equal to 0.5 mass % and less than or equal to 1.5 mass % relative to the mass of the positive electrode active material 32.

The positive electrode 11 having the above-described structure can be produced by applying a positive electrode slurry including the positive electrode active material 32, the conductive agent, the binder, and lithium carbonate 33 over a surface of the positive electrode core 30, drying the applied film, and compressing the dried film to form the positive electrode mixture layer 31 over both surfaces of the positive electrode core 30, and then cutting the structure in a predetermined size. For the positive electrode mixture slurry, two or more types of slurries having different contents of lithium carbonate 33 are used. When lithium carbonate 33 is not contained in the first region 31A (lower layer), and is contained only in the second region 31B (upper layer), a slurry which does not contain lithium carbonate 33 is applied over the positive electrode core 30 as a slurry for forming the lower layer. Then, a slurry including lithium carbonate 33 is applied over the applied film of the lower layer as a slurry for forming the upper layer.

### [Negative Electrode]

The negative electrode 12 includes a negative electrode core, and a negative electrode mixture layer formed over a surface of the negative electrode core. For the negative electrode core, there may be employed a foil of metal stable within a potential range of the negative electrode 12 such as copper, a film on a surface layer of which the metal is placed, or the like. The negative electrode mixture layer includes a negative electrode active material and a binder, and is desirably provided over both surfaces of the negative electrode core. The negative electrode 12 can be produced by, for example, applying a negative electrode mixture slurry including the negative electrode active material, a binder, or the like over the surface of the negative electrode core, drying the applied film, and compressing, to form the negative electrode mixture layer over both surfaces of the negative electrode core. The negative electrode mixture layer may include a conductive agent similar to those in the case of the positive electrode 11.

The negative electrode mixture layer includes, as the negative electrode active material, for example, a carbon material which reversibly occludes and releases lithium ions. Desirable examples of the carbon material include graphites such as natural graphites such as flake graphite, massive graphite, amorphous graphite, or the like, and artificial graphites such as massive artificial graphite (MAG), graphitized meso-phase carbon microbeads (MCMB), or the like. Alternatively, as the negative electrode active material, an active material may be employed which includes at least one of an element which forms an alloy with Li such as Si and Sn, and a compound containing the element. Desirable examples of the active material include a silicon material in which Si microparticles are dispersed in a silicon oxide phase or a silicate phase such as lithium silicate. For the negative electrode active material, for example, the carbon material such as graphite and the silicon material are used in combination.

For the binder contained in the negative electrode mixture layer, similar to the case of the positive electrode 11, the fluororesin, PAN, polyimide, the acrylic resin, polyolefin, or the like may be used, but desirably, styrene-butadiene rubber (SBR) is used. In addition, the negative electrode mixture layer desirably further includes CMC or a salt thereof, polyacrylic acid (PAA) or a salt thereof, polyvinyl alcohol (PVA), or the like. In particular, desirably, SBR, CMC or a salt thereof, and PAA or a salt thereof are used in combination.

### [Separator]

For the separator 13, a porous sheet having an ion permeability and an insulating property is employed. Specific examples of the porous sheet include a microporous thin film, a woven fabric, a non-woven fabric, or the like. As a material of the separator 13, there may be exemplified polyethylene, polypropylene, polyolefin such as a copolymer of ethylene and α-olefin, cellulose, polystyrene, polyester, polyphenylene sulfide, polyether ether ketone, a fluororesin, and the like. The separator 13 may have a single-layer structure or a layered structure. Alternatively, on a surface of the separator 13, a heat resistive layer including inorganic particles, or a heat resistive layer formed from a resin having a high heat endurance such as an aramid resin, polyimide, polyamide imide, or the like, may be formed.

### EXAMPLES

The present disclosure will now be described in further detail with reference to Examples. The present disclosure, however, is not limited to the Examples.

### Example 1

### [Preparation of First Positive Electrode Mixture Slurry]

A composite oxide represented by LiNi_{0.80}Co_{0.15}Al_{0.05}O₂ (having an average particle size of 12 μm) was used as a positive electrode active material. The positive electrode active material, acetylene black, and polyvinylidene fluoride were mixed with a mass ratio of 100:1:0.9, and N-methyl-2-pyrrolidone (NMP) was used as a dispersion medium, to prepare a first positive electrode mixture slurry.

### [Preparation of Second Positive Electrode Mixture Slurry]

The above-described positive electrode active material, acetylene black, polyvinylidene fluoride, and lithium carbonate (having an average particle size of 4 μm) were mixed with a mass ratio of 100:1:0.9:0.4, and NMP was used as the dispersion medium, to prepare a second positive electrode mixture slurry.

### [Production of Positive Electrode]

The second positive electrode mixture slurry was applied over one surface of a positive electrode core formed from an aluminum foil, and the applied film was dried. Then, over this applied film, the first positive electrode mixture slurry was applied, and the applied film was dried. With these processes, an applied film of a two-layer structure in which particles of lithium carbonate were dispersed in the lower layer was formed. In this process, amounts of application of the slurries were adjusted such that the mass per unit area was equal to each other. An applied film of the two-layer structure was also formed through a similar method over the other surface of the positive electrode core. The applied films were compressed using a roller, and the positive electrode core over which the applied films were formed was cut in a predetermined size, to produce a positive electrode in which the positive electrode mixture layer was formed over both surfaces of the positive electrode core.

### [Preparation of Non-Aqueous Electrolyte Solution]

Ethylene carbonate and ethylmethyl carbonate were mixed in a volume ratio of 3:7 (25° C.). LiPF₆ was added to the mixture solvent in a concentration of 1.0 mol/L, to prepare a non-aqueous electrolyte solution.

### [Production of Test Cell (Non-Aqueous Electrolyte Secondary Battery)]

The positive electrode described above and a negative electrode formed from a lithium metal foil were placed opposing each other with a separator therebetween, to form an electrode assembly, and the electrode assembly was housed in an outer housing formed from an aluminum laminated film. After the non-aqueous electrolyte solution was injected into the outer housing, the outer housing was sealed, to obtain a test cell A1.

### Example 2

A test cell A2 was produced in a manner similar to Example 1 except that the order of application of the first positive electrode mixture slurry and the second positive electrode mixture slurry was changed, and a positive electrode mixture layer was formed having a two-layer structure in which the particles of lithium carbonate are present in the upper layer.

### Comparative Example 1

A test cell B1 was produced in a manner similar to Example 1 except that only the first positive electrode mixture slurry was used, and a positive electrode mixture layer of a single-layer structure was formed.

### Comparative Example 2

The positive electrode active material described above, acetylene black, polyvinylidene fluoride, and lithium carbonate were mixed with a mass ratio of 100:1:0.9:0.2, and NMP was used as the dispersion medium, to prepare a third positive electrode mixture slurry. A test cell B2 was produced in a manner similar to Example 1 except that only the third positive electrode mixture slurry was used, and a positive electrode mixture layer of a single-layer structure was formed.

### [Overcharge Test]

Under a temperature condition of 25° C., the produced test cell was charged with a constant current of 0.1 C until a positive electrode potential reached 4.3 V based on lithium, and was then charged with a low voltage of 4.3 V until the current reached 0.01 C. Then, the test cell was discharged with a constant current of 0.05 C until the positive electrode potential reached 2.5 V. After this charging/discharging cycle was performed twice, an overcharge test was performed with a constant current of 0.1 C until the positive electrode potential reached 5.3 V based on lithium. A required time for the positive electrode potential to increase from 5.0 V to 5.1 V was measured. TABLE 1 shows this time. A difference in the increase time shown in TABLE 1 means a difference between each of the required times for the test cells A1, A2, and B2, and a required time for the test cell B1.

FIG. 3 shows an increase curve of the battery voltage in the overcharge test. In the test cells of Examples and Comparative Examples, a decomposition reaction of lithium carbonate starts to take place from a battery voltage near 5.0 V. Because the decomposition reaction of lithium carbonate is competitive with the electrode reaction, the increase of voltage becomes more gradual as the decomposition reaction of lithium carbonate becomes more dominant.

TABLE 1

| | LITHIUM CARBONATE | | OVERCHARGE TEST | |
|---|---|---|---|---|
| | CONTENT (MASS %) | | VOLTAGE | DIFFERENCE |
| | UPPER | LOWER | INCREASE | IN INCREASE |
| | LAYER | LAYER | TIME | TIME |
| B1 | 0 | 0 | 15.3 min | — |
| B2 | 0.2 | 0.2 | 25.2 min | 9.9 min |
| A1 | 0 | 0.4 | 26.8 min | 11.5 min |
| A2 | 0.4 | 0 | 28.7 min | 13.4 min |

As shown in TABLE 1 and FIG. 3, the test cells A1 and A2 of Examples have longer required times for increase of the voltage from 5.0 V to 5.1 V in comparison to the test cell B1 of Comparative Example 1 which does not contain lithium carbonate, and the increase of voltage is gradual. Further, the test cells A1 and A2 of Examples have gradual increases of voltage even in comparison to the test cell B2 of Comparative Example 2 having the same content of lithium carbonate relative to the mass of the positive electrode active material as a whole. That is, in the test cells A1 and A2 of Examples, the decomposition reaction of lithium carbonate progresses more quickly during the overcharging, in comparison to the test cell B2.

In the test cell B2, lithium carbonate is present uniformly in the thickness direction of the positive electrode mixture layer. On the contrary, lithium carbonate is present only in the upper layer (second region) of the positive electrode mixture layer in the test cell A1, and only in the lower layer (first region) of the positive electrode mixture layer in the test cell A2. While the detailed mechanism is yet unknown, it can be deduced that, when the content of lithium carbonate is the same, the decomposition reaction of lithium carbonate is promoted when lithium carbonate is present in a non-uniform concentration in the thickness direction of the positive electrode. Therefore, by using the positive electrode as in Examples, a quick actuation of the safety mechanism when the internal pressure reaches a predetermined value can be realized. In particular, it can be deduced that, when lithium carbonate is unevenly distributed in the upper layer, the advantage of promotion of decomposition of lithium carbonate becomes more significant due to an influence of a potential distribution in the thickness direction of the positive electrode mixture layer due to polarization.

The content of lithium carbonate needs to be controlled to greater than or equal to 0.05 mass % and less than or equal to 2 mass % relative to the mass of the positive electrode active material. When the content of lithium carbonate is lower than 0.05 mass %, the amount of generation of gas during overcharging becomes small, and sufficient advantage cannot be obtained. On the other hand, when the content exceeds 2 mass %, there is a possibility of reduction of the battery capacity and the battery characteristic under high-temperature environment.

### REFERENCE SIGNS LIST

10 non-aqueous electrolyte secondary battery, 11 positive electrode, 12 negative electrode. 13 separator, 14 electrode assembly. 16 outer housing can. 17 sealing assembly 18, 19 insulating plate, 20 positive electrode lead, 21 negative electrode lead, 22 grooved portion, 23 internal terminal plate, 24 lower vent member, 25 insulating member. 26 upper vent member, 27 cap, 28 gasket, 30 positive electrode core, 31 positive electrode mixture layer, 31A first region, 31B second region, 32 positive electrode active material, 33 lithium carbonate

1. A non-aqueous electrolyte secondary battery comprising:
a positive electrode;
a negative electrode;
a non-aqueous electrolyte; and
an outer housing, wherein
the outer housing includes a safety mechanism which is actuated when an internal pressure reaches a predetermined value,
the positive electrode comprises a positive electrode core and a positive electrode mixture layer formed over the positive electrode core,
the positive electrode mixture layer contains a positive electrode active material, and lithium carbonate in an amount of greater than or equal to 0.05 mass % and less than or equal to 2 mass % relative to a mass of the positive electrode active material, and
the lithium carbonate is present in a non-uniform concentration distribution in a thickness direction of the positive electrode mixture layer.

2. The non-aqueous electrolyte secondary battery according to claim 1, wherein
a content of the lithium carbonate is larger in a second region of the positive electrode mixture layer positioned at a surface side than in a first region positioned at a side of the positive electrode core.

3. The non-aqueous electrolyte secondary battery according to claim 2, wherein
the lithium carbonate is contained substantially only in the second region of the positive electrode mixture layer.

4. The non-aqueous electrolyte secondary battery according to claim 1, wherein
an average particle size of the lithium carbonate is smaller than an average particle size of the positive electrode active material.
